(19) United States
(12) Patent Application Publication
(10) Pub. No.: US 2020/0144012 A1
(43) Pub. Date: May 7, 2020

(54) SURGE PROTECTION DEVICE WITH CONNECTION ELEMENTS AND METHOD FOR PRODUCING SAME

(71) Applicant: PHOENIX CONTACT GMBH & CO.KG, Blomberg (DE)

(72) Inventors: Peter BERG, Schlangen (DE); Maik DITTERT, Bad Salzuflen (DE); Ralf LANGE, Horn-Bad Meinberg (DE)

(21) Appl. No.: 16/625,044

(22) PCT Filed: Jun. 22, 2018
(86) PCT No.: PCT/EP2018/066695

§ 371 Date: Dec. 20, 2019

(30) Foreign Application Priority Data
Jun. 22, 2017 (BE) BE2017/5443

(51) Int. Cl. H01H 71/14; H01H 71/04; H01H 71/02; H01H 69/00; H01C 7/12; H01T 4/04

(52) U.S. Cl. CPC H01H 71/14; H01H 71/04; H01H 71/0207; H01H 71/06; H01C 7/12; H01T 4/04; H01H 2071/046; H01H 69/00

(57) ABSTRACT

The invention relates to a surge protection device with connection elements, an overvoltage protection device (ÜSE1), two contact elements (K1, K2), a slide (AS), a connection plate (B) and a force accumulator (F). The two contact elements (K1, K2) and the overvoltage protection device (ÜSE1) are encased with an electrically nonconducting material on the surface. The electrically nonconducting material leaves open a connection area (A) formed on the second contact element (K2). In a first state, the connection plate (B) is connected to the connection area (A). The slide (AS) is arranged such that it can slide on a surface of the electrically nonconducting material under the action of the force when the thermally softenable contact means softens in a second state, wherein the slide (AS) is displaced between the connection plate (B) and the connection area (A). The electrically nonconducting material is assigned a further function.

### BACKGROUND OF THE INVENTION

Surge protection devices are known in the prior art. The surge protection devices comprise a conventional varistor. The varistor consists of a flat varistor ceramics, e.g., made of ZnO, outfitted with an electrode on both sides of the surface. The varistor ceramics and the electrodes are encased in epoxy resin for protection against environmental influences and also for protection against shock. For connection to other components, varistors are designed with leads, such as connection tabs or connection wires, which are not surrounded by epoxy resin.

Upon thermal overloading of a varistor, which may be induced for example by a heavy and/or long-lasting voltage surge or mains follow current or also as a long-term effect of aging by a leakage current, the varistor may “fuse,” whereupon the varistor may either become strongly heated or be explosively destroyed.

In order to prevent such effects, the surge protection devices are outfitted with disconnection devices, which interrupt the feed line to the varistor in event of a thermal overloading.

While on the one hand there is an increasing demand for surge protection devices, on the other hand one finds that the production costs of such devices are relatively high.

This is due among other things to the fact that the current surge protection devices are composed of many parts.

But this large number of components is not only costly and expensive in terms of production, it also represents a malfunction source.

Accordingly, one problem which the invention proposes to solve is to provide an improved surge protection device which is for one thing economical and reliable.

### Brief Presentation of the Invention

The problem is solved by a surge protection device with connection elements, wherein the surge protection device comprises an overvoltage protection device, wherein the surge protection device further comprises two contact elements, wherein the contact elements electrically contact the overvoltage protection device, wherein the first contact element is formed such that it at the same time also forms a first connection element, wherein the two contact elements and the overvoltage protection device are encased with an electrically nonconducting material on the surface, wherein the electrically nonconducting material leaves open a connection area formed on the second contact element, wherein the surge protection device furthermore comprises a connection plate, wherein the connection plate is formed such that it at the same time also forms a second connection element, wherein the connection plate in a first nontriggered state is connected to the connection area in electrically conducting manner by a thermally softenable contact means, wherein the surge protection device furthermore comprises a slide and a force accumulator, wherein the slide is arranged such that the slide can slide on a surface of the electrically nonconducting material under the action of the force from the force accumulator when the thermally softenable contact means softens in a second state, wherein the slide is displaced between the connection plate and the connection area, wherein the electrically nonconducting material is furthermore assigned at least one further function chosen from a group comprising: the electrically nonconducting material has a color which is different from the color of the slide, so that a displacement of the slide results in a color change in a local optical indicator, and/or the slide and the electrically nonconducting material each have molded guide elements, and/or the force accumulator is braced against a holding element which is formed in the electrically nonconducting material.

The problem is furthermore solved by a method for producing a surge protection device according to one of the preceding claims, involving the steps: obtaining an overvoltage protection device, obtaining a first contact element and a second contact element, arranging the obtained overvoltage protection device and the first contact element and the second contact element, and overmolding the previously arranged contact elements and the overvoltage protection device, wherein a connection area is left open on the second contact element, and wherein a further function is formed on the nonconducting material, chosen from a group comprising: the electrically nonconducting material has a color which is different from the color of the slide, so that a displacement of the slide results in a color change in a local optical indicator, and/or the slide and the electrically nonconducting material each have molded guide elements, and/or the force accumulator is braced against a holding element which is formed in the electrically nonconducting material.

Further advantageous embodiments are the subject matter in particular of the dependent claims.

### BRIEF PRESENTATION OF THE FIGURES

In the following, the invention is explained more closely with reference to the figures:

FIG. 1 shows a schematic exploded diagram of one embodiment of a surge protection device according to the invention,

FIG. 2a shows a schematic side view of a first side of the embodiment of FIG. 1 in a first, nontriggered, state,

FIG. 2b shows a schematic side view of a first side of the embodiment of FIG. 1 in a second, triggered, state,

FIG. 2c shows a schematic side view of a second side of the embodiment of FIG. 1,

FIG. 2d shows a sectional view of the embodiment of FIG. 1,

FIG. 3 shows a schematic exploded diagram of another embodiment of a surge protection device according to the invention,

FIG. 4a shows a schematic side view of a first side of the embodiment of FIG. 3 in a first, nontriggered, state,

FIG. 4b shows a schematic side view of a first side of the embodiment of FIG. 3 in a second, triggered, state,

FIG. 4c shows a schematic side view of a second side of the embodiment of FIG. 3,

FIG. 5 shows a schematic exploded diagram of yet another embodiment of a surge protection device according to the invention,

FIG. 6a shows a schematic side view of a first side of the embodiment of FIG. 5 in a first, nontriggered, state,

FIG. 6b shows a schematic side view of a first side of the embodiment of FIG. 5 in a second, triggered, state,

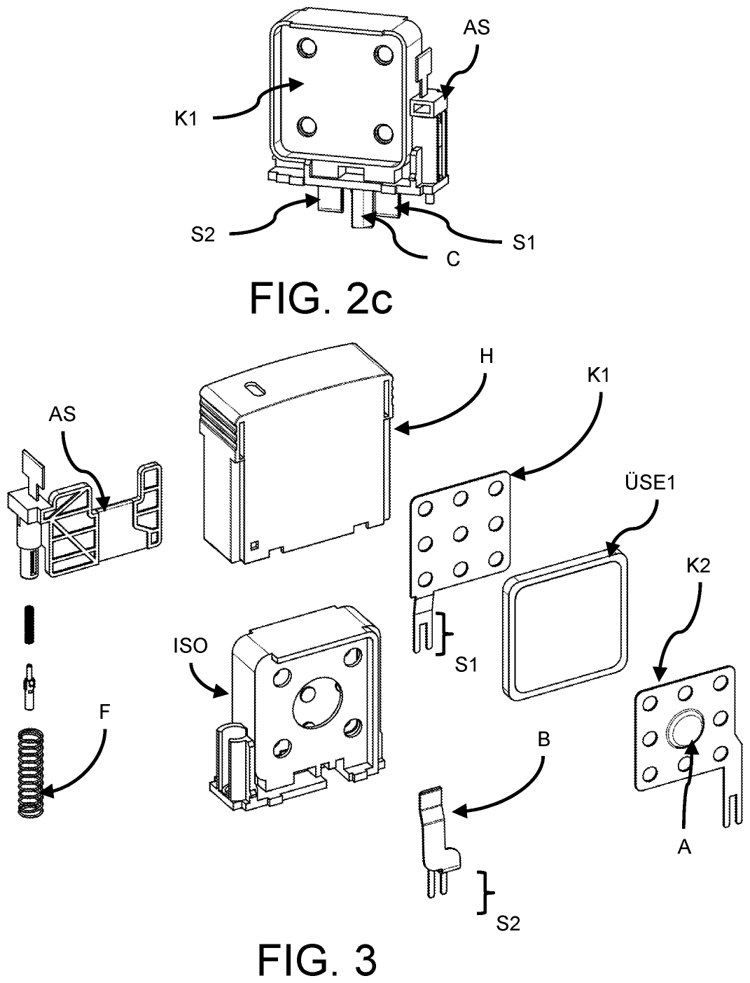

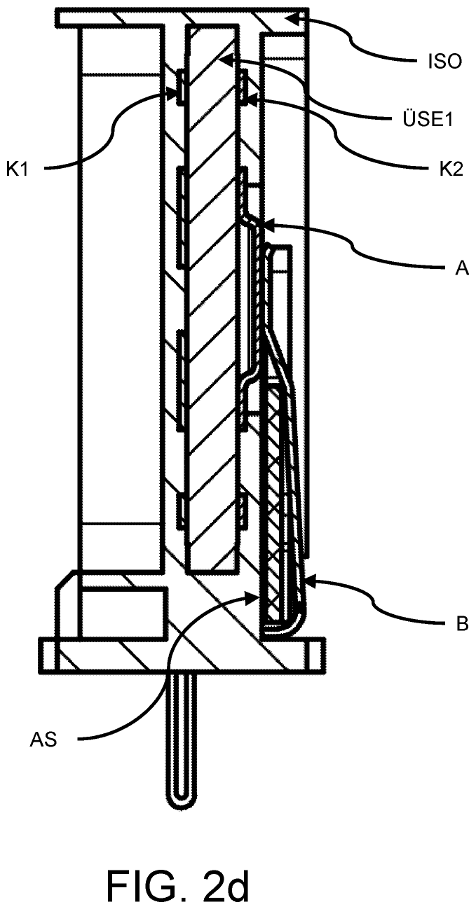

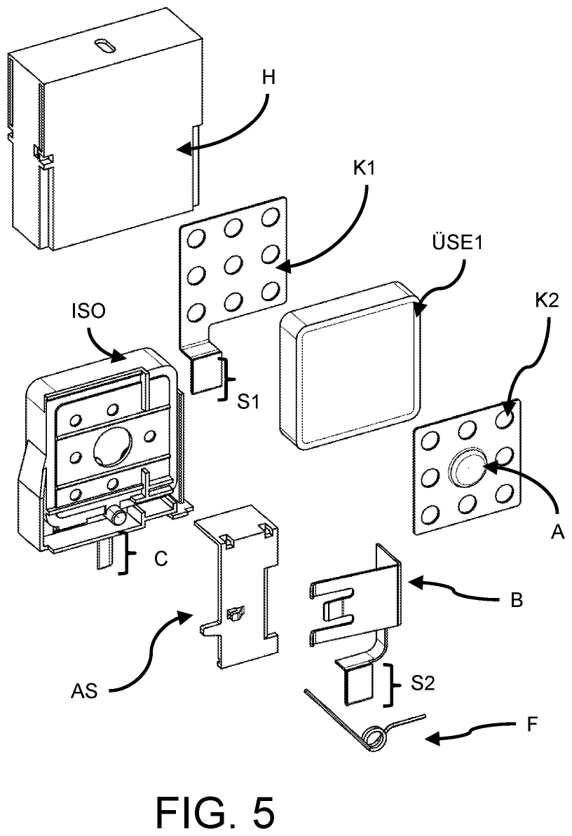

FIG. 2c shows a schematic side view of a second side of the embodiment of FIG. 5,

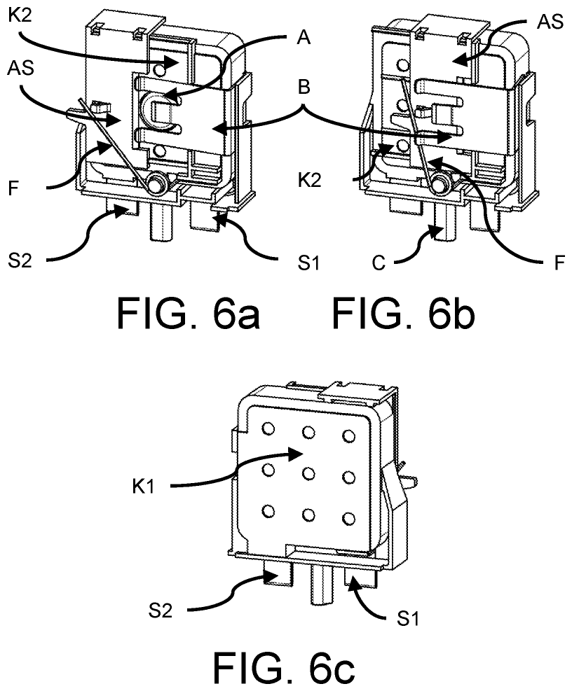

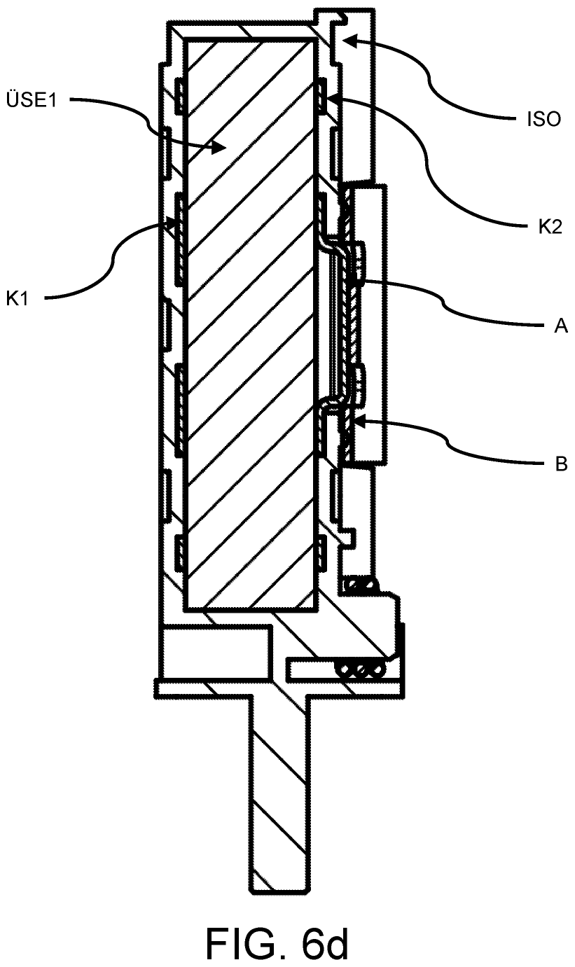

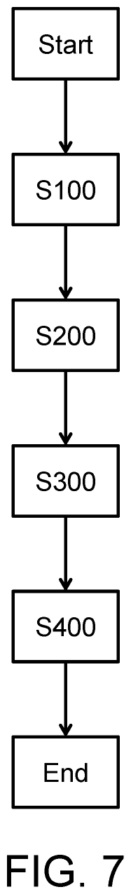

FIG. 6d shows a sectional view of the embodiment of FIG. 5, and

FIG. 7 shows a flow chart of an exemplary production process according to embodiments of the invention.

### DETAILED SPECIFICATION

The invention shall be presented in the following more closely with reference to the figure. It should be noted that different aspects are described, which may each be used alone or in combination. That is, any given aspect may be used with different embodiments of the invention, as long as it is not presented explicitly as a pure alternative.

Furthermore, for the sake of simplicity, we are generally always referring to just one single unit in the following. Unless explicitly mentioned, however, the invention may also comprise multiple such units.

Accordingly, the use of the words “a” or “an” should only be taken as an indication that at least one unit is used in a simple embodiment.

Furthermore, it should be noted that the sequence of the steps in the method may be chosen differently, or individual steps may be incorporated in one common step. Accordingly, the steps should merely be taken as a representation of certain aspects.

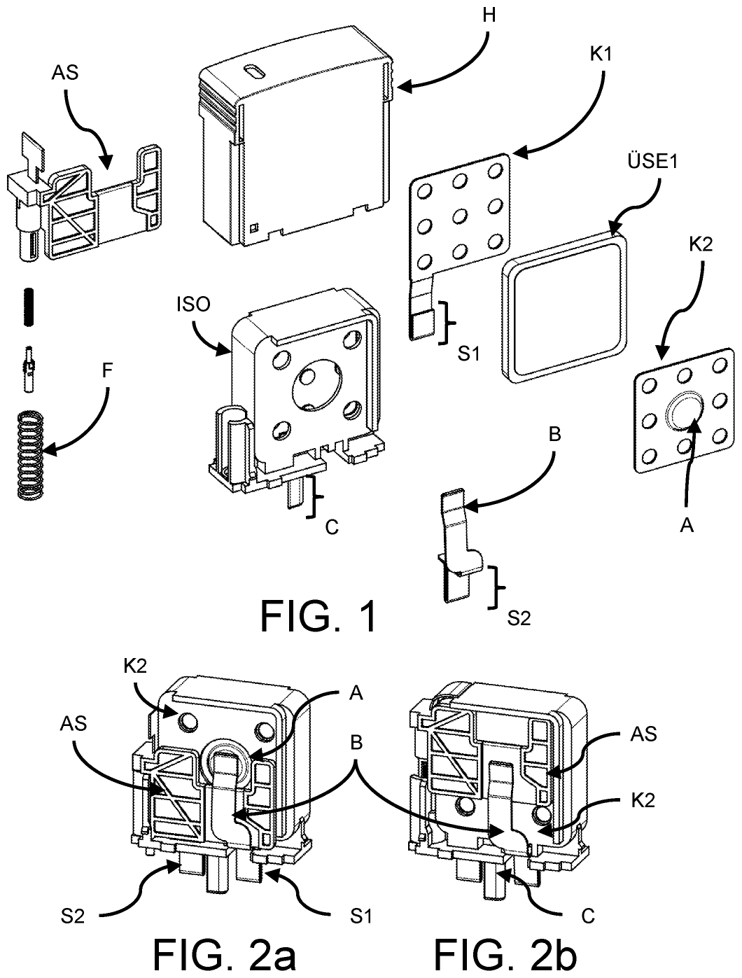

In FIGS. 1, 3 and 5, different embodiments are shown in an exploded diagram. The embodiments of the invention show a surge protection device with (plug-in or soldered) connection elements.

The surge protection device comprises (at least) one overvoltage protection device ÜSE1.

Furthermore, the surge protection device comprises (at least) two contact elements K1, K2. The contact elements K1, K2 contact the overvoltage protection device ÜSE1 electrically. Contact should be interpreted broadly here. Thus, the contact element may lie directly on the varistor ceramics or lie on a metallization which may under some circumstances be present on the varistor ceramics or be soldered to this.

The first contact element K1 is formed such that it at the same time also forms a first (plug-in or soldered) connection element S1 of the surge protection device. For example, at one end the contact element is formed as a plug blade (e.g., FIGS. 1 and 5) or as a solder element (e.g. FIG. 3) or as a screw element, etc.

The two contact elements K1, K2 and the overvoltage protection device ÜSE1 are encased (at least for a portion) in an electrically nonconducting material ISO on the surface, wherein the electrically nonconducting material ISO leaves open a connection area A formed on the second contact element K2.

That is, the contact element K2 located beneath the electrically nonconducting material ISO is electrically contactable in the connection area A. It should be noted that the area of the connection elements S1, S2 is likewise free of electrically nonconducting material ISO

The surge protection device furthermore comprises a connection plate B, wherein the connection plate B is formed such that it at the same time also forms a second (plug-in or soldered) connection element S2.

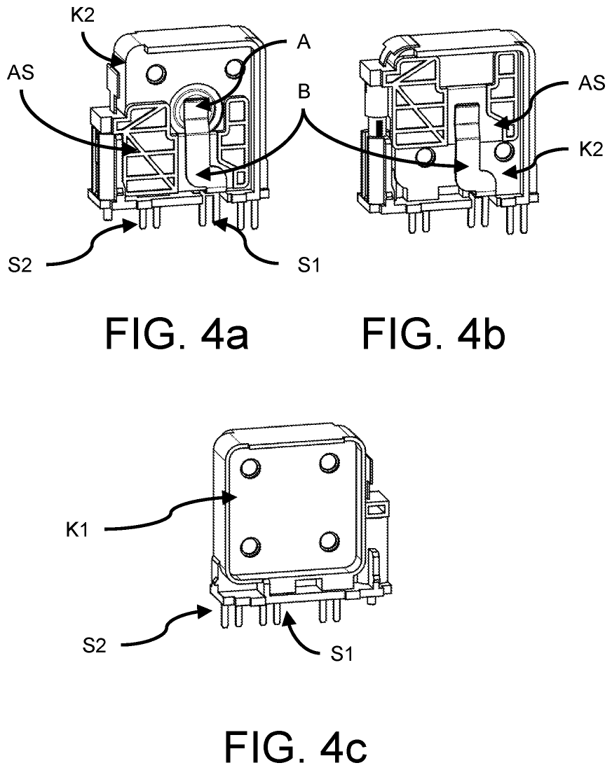

The connection plate B is connected in an electrically conducting manner in a first nontriggered state, which is shown in FIGS. 2a, 4a and 6a, to the connection area A by a thermally softenable contact means, such as a solder or a glue.

Furthermore, the surge protection device comprises a slide AS and a force accumulator F, wherein the slide AS is arranged such that it can slide on a surface of the electrically nonconducting material under the action of the force from the force accumulator F when the thermally softenable contact means softens in a second triggered state, shown in FIGS. 2b, 4b and 6b, wherein the slide AS is displaced between the connection plate B and the connection area A. Only a displacement is shown in the figures. But a rotation or a combination of rotation and displacement may also be used with the same effect.

Furthermore, the electrically nonconducting material ISO is assigned at least one further function. The function is, for example, that the electrically nonconducting material ISO has a color which is different from the color of the slide AS, so that a displacement of the slide AS results in a color change in a local optical indicator. That is, a color change can be used to signal a triggered state. That is, the electrically nonconducting material ISO is assigned an additional function in the form of the signaling.

Alternatively or additionally, it may be provided that the slide AS and the electrically nonconducting material ISO each have molded guide elements. That is, the electrically nonconducting material ISO is assigned an additional task in the form of a mechanical bracing.

Alternatively or additionally, it may be provided that the force accumulator F is braced against a holding element which is formed in the electrically nonconducting material ISO. That is, the electrically nonconducting material ISO is assigned a (further) additional task in the form of a mechanical bracing guidance.

As a result, this leads to a reduction in parts. The reduction in parts, in turn, leads to lower production costs and increased safety. In particular, the contact elements K1, K2 as well as the connection plate B can be designed as cost-effective punched and/or punched/bent parts.

In embodiments of the invention, the overvoltage protection device ÜSE1 comprises a varistor and/or a spark gap and/or a gas arrester. That is, the invention can be used with many different overvoltage protection devices, resulting in a reduction of parts in each case.

In further alternative or additional embodiments, the two contact elements K1, K2 are soldered to the overvoltage protection device ÜSE1. With suitable choice of the process parameters during production, a soldering can be provided for example in an overmolding step S400.

In further alternative or additional embodiments, the electrically nonconducting material ISO comprises a thermoplastic or a thermosetting plastic or an epoxy resin.

In further alternative or additional embodiments, the connection area A, as shown in FIGS. 2d and 6d, is a protrusion on the second contact plate K2. The protrusion ensures a specific current distribution and in the event of a fault results in a thermally preferred process, so that a rapid disconnecting of the separation point formed from the connection plate B and the contact element K2 is assured. Furthermore, the protrusion enables an especially secure soldering of the separation point.

In further alternative or additional embodiments, which are shown e.g. in FIGS. 2a, 2b and 6a and 6b, at least one mechanical coding C is also formed on the electrically nonconducting material ISO, serving to indicate a power class.

That is, the coding C may prevent, for example, the insertion of surge protection devices belonging to the wrong power class into a socket with an unsuitable coding receptacle. This can prevent damage to the equipment being protected.

The electrically nonconducting material can readily comprise a holding device for the second (plug-in or soldered) connection element S2 and/or for the connection plate B. That is, the connection plate B is held and can thus be soldered to the connection area A with no further measures.

Moreover, the surge protection device may furthermore comprise a housing G. The housing may be formed (at least in part) by the electrically nonconducting material ISO. Furthermore, a hood H may be provided. The electrically nonconducting material ISO may then also comprise molded holding elements (such as latching elements) for the hood H.

Without limiting the generality, the surge protection device may comprise a telecommunications interface. The telecommunications interface may be activated directly or indirectly, e.g., by the springing open of the contact plate B or by displacement of the slide AS.

In embodiments of the invention, the two contact elements K1, K2 and the overvoltage protection device ÜSE1—apart from the connection area A—are overmolded with the electrically nonconducting material ISO on the surface. That is, a reliable connection can be provided along with good shock protection and protection against surrounding influences.

As already mentioned before, it may also be provided that the contact elements K1, K2 lie directly against a varistor ceramics and/or metallizations of the overvoltage protection device ÜSE1 without soldering or gluing to the surface. In this case, the electrical contacting is provided by holding forces solely by the supporting with electrically nonconducting material ISO. This leads to a further cost reduction, since a soldering process step can now be omitted.

The above-presented embodiments of the surge protection device can be manufactured especially easily.

In one step S100, an overvoltage protection device ÜSE1 is obtained. In a further step S200, which can be carried out in parallel with step S100 or also prior in time to step S100 or even overlapping in time with step S100, a first contact element K1 and a second contact element K2 are obtained.

A further step S300, which may coincide with step S100 and/or step S200, involves the arrangement of the obtained overvoltage protection device ÜSE1 and the obtained first contact element K1 and the second contact element K2.

For example, at first the first contact element K1 is obtained, then the overvoltage protection device ÜSE1 is obtained and arranged on the first contact element K1. Then the second contact element K2 is obtained and arranged on the arrangement of the overvoltage protection device ÜSE1 and the first contact element K1.

After the elements are positioned appropriately, they are overmolded in a further step S400. Given suitable choice of process parameters, a soldering process may also be initiated with the overmolding. In such a case, of course, a suitable solder must first be introduced between the corresponding elements. But it would also be easily possible to provide a soldering step separately and prior to the overmolding, or even after the overmolding if the overmolding material changes its temperature properties during or after the overmolding.

During the overmolding, at least one of the aforementioned further functions is formed on the nonconducting material ISO.

Of course, semifabricated products which provide the results of individual manufacturing steps may likewise be incorporated into an appropriately adapted production process.

That is, no longer are any additional components needed thanks to the invention. In particular, one of the (plug-in or soldered) device leads K1/S1 already directly forms a direct connection of the overvoltage protection device ÜSE1.

The overvoltage protection device ÜSE1 is encased (at least partially) in electrically nonconducting material ISO, which provides for other functions as well as the protection against environmental influences and shock protection. In particular, the electrically nonconducting material ISO provides at least a portion of a housing and/or a color coding for a status indication and/or a coding and/or holding elements and/or guide elements.

In particular, when there are lesser demands on the surge protection device, a soldering of the contact elements K1, K2 to the overvoltage protection device ÜSE1 may be omitted, since the contact force between the overvoltage protection device ÜSE1 and the contact elements K1, K2 is sufficiently provided by the overmolded electrically nonconducting material ISO.

In conclusion, it should be mentioned once more that the term “overmolding” should be interpreted broadly and may also be understood as an encasing, e.g., in a shaping process.

### LIST OF REFERENCE SYMBOLS

ÜSE1 Overvoltage protection device
K1, K2 Contact element
S1, S2 Connection element
A Connection area
B Connection plate
AS Slide
F Force accumulator
C Coding
H Hood

### STEPS OF THE METHOD

S100 obtaining an overvoltage protection device
S200 obtaining a first contact element and a second contact element
S300 arranging the obtained overvoltage protection device and the first contact element and the second contact element
S400 overmolding the previously-arranged contact elements and the overvoltage protection device

What is claimed is:

1. A surge protection device with connection elements, wherein the surge protection device comprises an overvoltage protection device, wherein the surge protection device further comprises two contact elements, wherein the contact elements electrically contact the overvoltage protection device, wherein the first contact element is formed such that it at the same time also forms a first connection element (S1), wherein the two contact elements and the overvoltage protection device are encased with an electrically nonconducting material on the surface, wherein the electrically nonconducting material leaves open a connection area formed on the second contact element, wherein the surge protection device furthermore comprises a connection plate, wherein the connection plate is formed such that it at the same time also forms a second connection element, wherein the connection plate in a first nontriggered state is connected to the connection area in an electrically conducting manner by a thermally softenable contact means, wherein the surge protection device furthermore comprises a slide and a force accumulator, wherein the slide is arranged such that it can slide on a surface of the electrically nonconducting material under the action of the force from the force accumulator when the thermally softenable contact means softens in a second state, wherein the slide is displaced between the connection plate and the connection area, wherein the electrically nonconducting material is furthermore assigned a further function chosen from a group comprising: the electrically nonconducting material has a color which is different from the color of the slide, so that a displacement of the slide results in a color change in a local optical indicator, and/or the slide and the electrically nonconducting material each have molded guide elements, and/or the force accumulator is braced against a holding element which is formed in the electrically nonconducting material.

2. The surge protection device according to claim 1, wherein the overvoltage protection device comprises a varistor and/or a spark gap and/or a gas arrester.

3. The surge protection device according to claim 1, wherein the two contact elements are soldered to the overvoltage protection device.

4. The surge protection device according to claim 1, wherein the electrically nonconducting material comprises a thermoplastic or a thermosetting plastic or an epoxy resin.

5. The surge protection device according to claim 1, wherein the connection area is a protrusion on the second contact plate.

6. The surge protection device according to claim 1, wherein furthermore at least one mechanical coding is formed on the electrically nonconducting material, serving to indicate a power class.

7. The surge protection device according to claim 1, wherein the electrically nonconducting material comprises a holding device for the second connection element.

8. The surge protection device according to claim 1, wherein the surge protection device furthermore comprises a housing.

9. The surge protection device according to claim 8, wherein the electrically nonconducting material forms at least a portion of the housing.

10. The surge protection device according to claim 8, wherein the electrically nonconducting material comprises molded holding elements for a hood.

11. The surge protection device according to claim 1, furthermore comprising a telecommunications interface.

12. The surge protection device according to claim 1, wherein the two contact elements and the overvoltage protection device are overmolded with the electrically nonconducting material on the surface.

13. The surge protection device according to claim 1, wherein the electrically nonconducting material holds the two contact elements electrical contact on the overvoltage protection device.

14. The surge protection device according to claim 1, wherein the first connection element and/or the second connection element is formed as a plug-in plate or as a solder pin.

15. A method for producing a surge protection device, comprising:
obtaining an overvoltage protection device;
obtaining a first contact element and a second contact element;
arranging the obtained overvoltage protection device and the first contact element and the second contact element; and
overmolding the previously-arranged contact elements and the overvoltage protection device, wherein a connection area is left open on the second contact element, and wherein a further function is formed on the nonconducting material, chosen from a group comprising: the electrically nonconducting material has a color which is different from the color of the slide, so that a displacement of the slide results in a color change in a local optical indicator, and/or the slide and the electrically nonconducting material each have molded guide elements, and/or the force accumulator is braced against a holding element which is formed in the electrically nonconducting material.
